(19) United States
(12) Patent Application Publication
(10) Pub. No.: US 2023/0252054 A1
(43) Pub. Date: Aug. 10, 2023

(54) PROVIDING A STATE-OF-THE-ART SUMMARIZER

(71) Applicant: INTERNATIONAL BUSINESS MACHINES CORPORATION, Armonk, NY (US)

(72) Inventors: Yufang HOU, Dublin (IE); Debasis GANGULY, Dublin (IE); Martin GLEIZE, Dublin (IE); Stephane DEPARIS, Dublin (IE)

(73) Assignee: INTERNATIONAL BUSINESS MACHINES CORPORATION, Armonk, NY (US)

(21) Appl. No.: 17/650,636

(22) Filed: Feb. 10, 2022

(51) Int. Cl. G06F 16/28

(52) U.S. Cl. CPC G06F 16/287

(57) ABSTRACT

Embodiments for analysis and summarization of current knowledge of data by a processor. A topic of a knowledge domain may be identified and extracted from one or more one or more data sources. A list of candidate subtopics, summaries, and a plurality of related data associated with the topic may be generated.

### BACKGROUND OF THE INVENTION

### Field of the Invention

The present invention relates in general to computing systems, and more particularly to, various embodiments for providing analysis and summarization of current knowledge of data by a processor.

### Description of the Related Art

In today’s society, consumers, businesspersons, educators, and others communicate over a wide variety of mediums in real time, across great distances, and many times without boundaries or borders. The advent of computers and networking technologies has made possible the intercommunication of people from one side of the world to the other. These computing systems allow for the sharing of information between users in an increasingly user friendly and simple manner. The increasing complexity of society, coupled with the evolution of technology, continues to engender the sharing of a vast amount of information between people.

### SUMMARY OF THE INVENTION

Various embodiments for providing analysis and summarization of current knowledge of data by a processor, are provided. In one embodiment, by way of example only, a method for providing analysis and summarization of current knowledge of data, again by a processor, is provided. A topic of a knowledge domain may be identified and extracted from one or more one or more data sources. A list of candidate subtopics, summaries, and a plurality of related data associated with the topic may be generated.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention.

FIG. 2 is an additional block diagram depicting an exemplary cloud computing environment according to an embodiment of the present invention.

FIG. 3 is an additional block diagram depicting abstraction model layers according to an embodiment of the present invention.

FIG. 4 is an additional block diagram depicting an exemplary functional relationship between various aspects of the present invention.

FIG. 5 is a block/flow diagram depicting an exemplary operations for providing analysis and summarization of current knowledge of data in a computing environment by a processor in which aspects of the present invention may be realized.

FIG. 6 is a diagram depicting exemplary pseudocode for providing analysis and summarization of current knowledge of data in a computing environment in a computing environment by a processor in which aspects of the present invention may be realized.

### DETAILED DESCRIPTION OF THE DRAWINGS

As the amount of electronic information continues to increase, the demand for sophisticated information access systems also grows. Digital or “online” data has become increasingly accessible through real-time, global computer networks. The data may reflect many aspects of topics ranging from scientific, legal, educational, financial, travel, shopping and leisure activities, healthcare, and so forth. Many data-intensive applications require the extraction of information from data sources. The extraction of information may be obtained through a knowledge generation process that may include initial data collection among different sources, data normalization and aggregation, and final data extraction.

Moreover, as the volume of electronic information grows (e.g., scientific literature), it is difficult for domain experts to keep up-to-date while also dedicating time to their profession. For example, domain experts face a variety of questions such as, for example, “How do I solve a problem,” “What are the known tasks that this problem can be mapped to,” “What are the existing models and the state-of-the-art (“SoTA”).” Without the domain expert maintaining up-to-date knowledge pertaining to a particular knowledge domain, these questions may be inadequately answered and addressed.

Accordingly, various embodiments are provided herein for providing analysis and summarization of current knowledge of data, again by a processor, is provided. A topic of a knowledge domain may be identified and extracted from one or more one or more data sources. A list of candidate subtopics, summaries, and a plurality of related data associated with the topic may be generated. In one aspect, the communications (e.g., conversations) and the contexts of the communications may be tracked from multiple resources or data sources (e.g., video data, audio data, social media posts, video/audio threads, channels, protocols, email, short mail service (“SMS”) messages, voice data/messages, and the like) on different applications and/or devices. Thus, the present invention enables a domain expert to benefit from the massive amount of knowledge embedded in domain-specific literature and other related data resources, while providing rapid delivery (e.g., real-time delivery) of the information.

That is, the present invention may take as input a problem description identified in a data source and generate a list of candidate related subproblems, elaborating (e.g., a concise summary) the relevant information (e.g., leaderboards, code resources, bibliographic references etc. ) for each of the candidate related subproblems.

In some implementations, the present invention provides for assisting a domain exert, which is able to help a final user (e.g., the domain exert) to fill their knowledge gap when facing a new problem such as, for example, when a data scientist is working on sentiment analysis for a client’s social media dataset and needs advice on the latest, most up-to-date and advanced sentiment analysis techniques.

To further illustrate, consider the following example scenarios. In a first example, consider an artificial intelligence (“AI”) practitioner desiring to build an effective machine learning model for predicting outcomes of randomized control trials (RCTs) for a particular subject. Assume each RCT is an unstructured text (e.g., a paper in PDF format), with results presented in diverse ways (e.g., figures, tables, text). In this scenario, the present invention assist the AI practitioner by the following operation.

First, the present invention may identify and recommend a workflow comprised of subtasks to address an original overall problem (e.g., PDF parsing, table extraction, table understanding, information extraction, entity linking, knowledge graph construction, and/or representation learning with Knowledge Graph).

Second, the present invention may summarize the related SoTA AI research for each sub-task. For instance, a leaderboard may be constructed from recent AI literature for each sub-task and presents the numeric results along with the summary of the dataset, methods, and/or experiment settings on popular benchmark datasets.

In a first example, consider where audio and video data need to be translated from one language to another (e.g., translating English to French). Assume, a domain expert desires to build a system to transcribe an English video into French. In this scenario, the present invention assist the domain by receiving a simple query “how do you translate the video from English to French and offer relevant paths for the domain expert to follow. That is, the present invention may identify and recommend a workflow flow comprised of sub-tasks addressing the problem (e.g., provide up-to-date video decoding, speech-to-text, and machine translation operations).

Second, the present invention may summarize the related SoTA AI research for each sub-task. For instance, a leaderboard may be constructed from recent AI literature for each sub-task and presents the numeric results along with the summary of the dataset, methods, and/or experiment settings on popular benchmark datasets. The present invention provides, as output to the domain expert, current and the most advanced, known, and/or tested methods that can solve several subtasks at once (e.g., there is an advanced method that can work on a neural network system directly transcribing speech into subtitles in another language).

In some implementations, the present invention provides current information with various methods, operations, testing, and real-time data shown in leaderboards. That is, the present invention provides a summary of the most advanced, known operations (e.g., SoTA AI papers) may be provided in the form of a leaderboard (e.g., a scalable leaderboard). The summary also links different elements of a study (e.g., a task, dataset, metric, and/or method) together and recommend a workflow solution based on the linked elements.

A multi-faceted result list interface which shows the sub-topics along with further exploration, may be provided. A knowledge graph may be automatically constructed from the data in the leaderboards. Additionally, an interactive question/answer (“QA”) system may be provided to a user that is enabled to answer various problems/queries and recommend each optimal, maximized, and/or best solution for a specific problem/query.

In one aspect, data such as, for example, communications, from one or more computing devices, having text data (e.g., transcripts of discussions, emails, blogs, social media posts,) or audio and/or video recordings (with possible timestamps) may be received and gathered. The communications (e.g., text data, audio data, visual data) may be processed so as to 1) automatically transcribe speech data (for audio data) and/or process video data, 2) identify speakers/participants for each specific audio utterance of the data, 3) identify segments within the data pertaining to transactional discussions (e.g., sales discussion) along with the transaction topic, 4) automatically extract mentions of transactional elements, for example criteria, alternatives, tradeoffs, constraints, etc., 5) group, cluster, and/or organize extracted information (including mapping decision alternatives and criteria of each transaction), 6) enrich concepts of the transactions/communications by linking the transactions/communications to a domain knowledge (e.g., dbpedia), and/or 7) identify expressed sentiment by one or more participants towards raised transactional elements in the communication (e.g., during a meeting, presentation, sales call, etc.). In other words, the present invention may digest and process the audio data, video data, and/or text data for extracting one or more decision elements that may be grouped, coordinated, and organized for later processing.

The mechanisms of the illustrated embodiments may provide a structured summary of the leaderboard so as to enable a user, participant, or other third party to interact with the structured summary via multi-faceted results. The structured summary may be displayed on an interactive graphical user interface (“GUI”) as a visual representation (e.g., multi-faceted tabs) of the summary. The visual representation of the summary may a) enable users to filter on the multi-faceted tabs that may include keywords, authors/contributors, dates, and/or other selected aspects, b) scrutinize each piece of extracted information in context so as to determine (either automatically performed and/or via a user) as to whether the extracted information was correctly identified or not or simply to help the user understand the meaning, etc., and/or c) 8) identify expressed sentiment by one or more participants towards a recommended workflow. Other examples of various aspects of the illustrated embodiments, and corresponding benefits, will be described further herein.

In one aspect, the GUI may be provided so as to enable a user to interact with a summary table, containing the summary of SoTA knowledge, to visualize extracted information under different formats enriched with links to external knowledge to support one or more recommended workflows. Each atomic piece of extracted information associated with each extracted element may be scrutinized, analyzed, edited, corrected, confirmed, and/or rejected. The extracted information may be displayed in the leaderboard with multi-faceted result tabs and may be filtered by date, time, and/or authors for selected use cases (or to provide users to focus on a subset of the speakers). One or more suggestions or recommendations relating to linked SoTA knowledge may be provided. In one aspect, the suggestions and/or recommendations may be ranked according to identified criteria.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

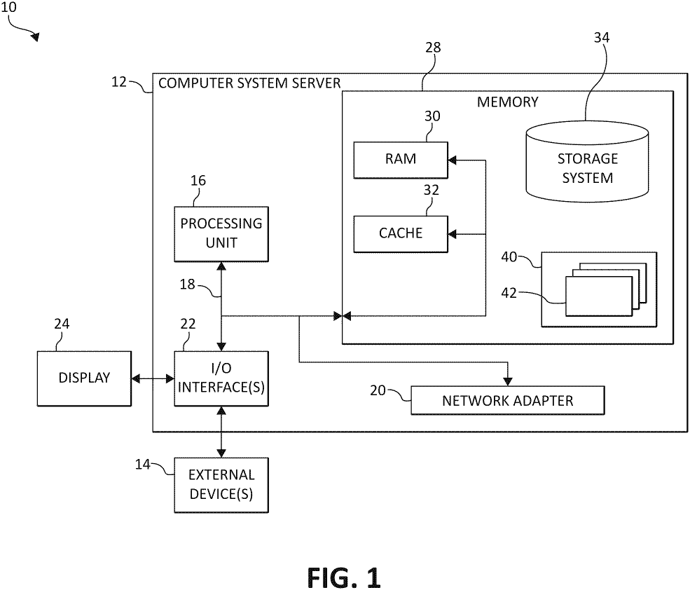

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

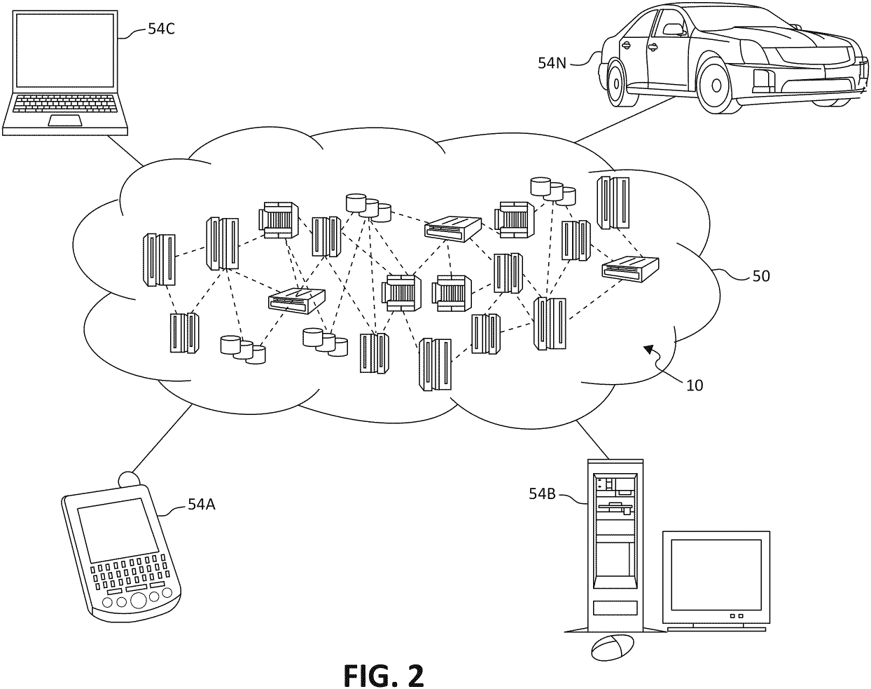

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

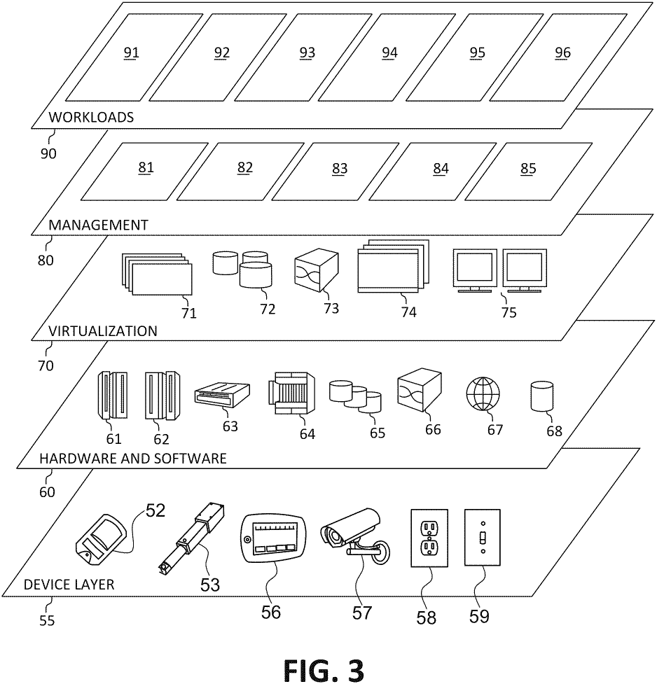

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing analysis and summarization of current knowledge of data. In addition, workloads and functions 96 for providing analysis and summarization of current knowledge of data may include such operations as data analytics, data analysis, and as will be further described, notification functionality. One of ordinary skill in the art will appreciate that the workloads and functions 96 for providing analysis and summarization of current knowledge of data may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the mechanisms of the illustrated embodiments provide novel approaches for providing analysis and summarization of current knowledge of data, again by a processor, is provided. A topic of a knowledge domain may be identified and extracted from one or more one or more data sources. A list of candidate subtopics, summaries, and a plurality of related data associated with the topic may be generated.

In some implementations, the present invention provides novel approaches for providing analysis and summarization of current knowledge of data by taking a problem description as input and outputs a list of candidate related subproblems, elaborating (e.g., a concise summary) the relevant information (e.g., leaderboards, code resources, bibliographic references etc.) for each candidate related subproblem. A confidence estimator score may be assigned to indicate how relevant the subproblem is to the overall problem statement. An interactive leaderboard summary may be generated and displayed to indicate how advanced the current domain knowledge (e.g., research, studies, domain authority/scientific papers, technology) is the subproblem, e.g., understanding the semantics of tabular data.

The present invention provides and generates a multi-faceted output in the form of expandable facets (tabs) showing data from tables, figures, equations, leaderboards and a text summary. A domain specific ontology and a selected amount of annotated dataset can be applied to different scientific domains.

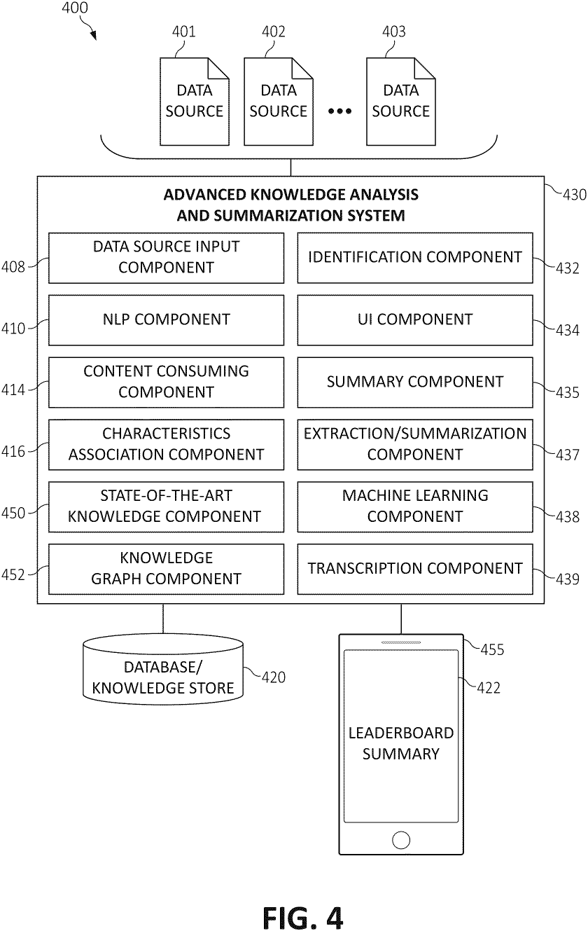

For further explanation, FIG. 4 is a block diagram of exemplary functionality 400 relating to transaction interaction analysis and summarization is depicted. As shown, the various blocks of functionality are depicted with arrows designating the blocks’ 400 relationships with each other and to show process flow. Additionally, descriptive information is also seen relating each of the functional blocks 400. With the foregoing in mind, the module blocks 400 may also be incorporated into various hardware and software components of a system for transaction interaction analysis and summarization methods and features in accordance with the present invention, such as those described in FIGS. 1-3. Many of the functional blocks 400 may execute as background processes on various components, either in distributed computing components, or on the user device, or elsewhere.

Multiple data sources 401-403 may be provided by one or more content contributors. The data sources 401-403 may be provided as a corpus or group of data sources defined and/or identified. The data sources 401-403 may include, but are not limited to, data sources relating to one or more documents, materials related to emails, books, scientific papers, online journals, journals, articles, drafts, audio data, video data, and/or other various documents or data sources capable of being published, displayed, interpreted, transcribed, or reduced to text data. The data sources 401-403 may be all of the same type, for example, pages or articles in a wiki or pages of a blog. Alternatively, the data sources 401-403 may be of different types, such as word documents, wikis, web pages, power points, printable document format, or any document capable of being analyzed by a natural language processing system.

In addition to text based documents, other data sources such as audio, video or image sources may also be used wherein the audio, video or image sources may be pre-analyzed to extract or transcribe their content for natural language processing, such as converting from audio to text and/or image analysis. For example, a voice command issued by a content contributor may be detected by a voice-activated detection device and record each voice command or communication. The recorded voice command/communication may then be transcribed into text data for natural language processing. As an additional example, one or more of the data sources 401-403 may be a video capturing device (e.g., a camera) that may record a video such as, for example, a webinar or meeting where cameras are installed in a room for broadcasting the meeting to remote locations where various intellectual property content contributors may collaborate remotely. The video data captured by the video capturing device may be analyzed and transcribed into images or text data for natural language processing.

A data source input component 408 may consume and/or receive the group of data sources 401-403 for THE advanced knowledge analysis and summarization system 430 using natural language processing (NLP) and artificial intelligence (AI) to provide processed content.

The data sources 401-403 may be analyzed by an NLP component 410 (and a transcription component 439 if necessary) to data mine or transcribe relevant information from the content of the data sources 401-403 (e.g., documents, emails, reports, notes, audio records, video recordings, live-streaming communications, etc.) in order to display the information in a more usable manner and/or provide the information in a more searchable manner. The NLP component 410 may be provided as a cloud service or as a local service.

The advanced knowledge analysis and summarization system 430 may include the NLP component 410, a content consuming component 414, a characteristics association and component 416. The NLP component 410 may be associated with the content consuming component 414. The content consuming component 414, in association with the data source input component 408, may be used for inputting the data sources 401-403 and running NLP and AI tools against them, learning the content, such as by using the machine learning component 438. It should be noted that other components of FIG. 4 may also employ one or more NLP systems and the NLP component 410 is merely illustrated by way of example only of use of an NLP system. As the NLP component 410 (including the machine learning component 438) learns different sets of data, the characteristics association component 416 (or “cognitive characteristics association component”) may use the artificial intelligence to make cognitive associations or links between data sources 401-403 by determining common concepts, methods, features, similar characteristics, topics, and/or sub-topics.

Intelligence (e.g., “cognition”) is the mental process of knowing, including aspects such as awareness, perception, reasoning and judgment. An AI system uses artificial reasoning to interpret the data sources 401-403 and extract their topics, ideas, or concepts. The learned decisions, decision elements, alternatives to the decision, alternative options/choices, decision criteria, concepts, suggestions, topics and subtopics of a domain of interest, may not be specifically named or mentioned in the data sources 401-403 and is derived or inferred by the AI interpretation.

The learned content of the data sources consumed by the NLP system may be merged into a database 420 (and/or knowledge store) or other data storage method of the consumed content with learned concepts, methods, and/or features of the data sources 401-403 providing association between the content referenced to the original data sources 401-403.

The database 420 may also work in conjunction with the transcription component 439 to maintain a timestamped record of all interactions and contributions of each content contributor, decision, alternative, criteria, subject, topic, or idea. The database 420 may record and maintain the evolution of decisions, alternatives, criteria, subjects, topics, ideas, or content discussed in the data sources 401-403.

The database 420 may track, identify, and associate all communication threads, messages, transcripts, and the like of all data generated during all stages of the development or “life cycle” of the decisions, decision elements, alternatives, choices, criteria, subjects, topics, subtopics, or ideas. The merging of the data into one database 420 (which may include a domain knowledge) allows the advanced knowledge analysis and summarization system 430 to act like a search engine, but instead of keyword searches, it will use an AI method of making cognitive associations between the data sources using the deduced concepts.

The advanced knowledge analysis and summarization system 430 may include a user interface (“UI”) component 434 (e.g., an interactive graphical user interface “GUI”) providing user interaction with the indexed content for mining and navigation and/or receiving one or more inputs/queries from a user. More specifically, the user interface component 434 may be in communication with a wireless communication device 455 (see also the PDA or cellular telephone 54A, the desktop computer 54B, the laptop computer 54C, and/or the automobile computer system 54N of FIG. 2.) for also providing user input for inputting data such as, for example, data sources 401-403 and also providing user interaction with a summary (e.g., a leaderboard summary 422). The wireless communication device 455 may use the UI component 434 (e.g., GUI) for providing input of data and/or providing a query functionality such as, for example, interactive GUI functionality for enabling a user to enter a query in the GUI 422 relating to a domain of interest, topic, decision, alternative, criteria, summary of decisions, and/or an associated objective. For example, GUI 422 may display a summary (e.g., a summary of the decision elements, alternatives, and/or criteria) as the leaderboard summary 422 which may link different elements of a study (e.g., a task, dataset, metric, and/or method) together and recommend a workflow solution based on the linked elements while also retrieving any technical description to the study (e.g., a task, dataset, metric, and/or method) along with illustrative figures and equations as accessory information.

The advanced knowledge analysis and summarization system 430 may also include an identification component 432. The identification component 432 may use data retrieved directly from one or more data sources or stored in the database 420 (or multiple immutable ledgers). The identification component 432 may identify and extract a topic of a knowledge domain from the one or more data sources 401-403 or retrieve from the database 420. The identification component 432 may identify domain of interest, topic, decision, alternative, criteria, summary of decisions, and/or an associated objective.

The identification component 432 may include using a processing (pre-processing and/or post-processing) analytics component 450, to assist with identifying a domain of interest, topic, decision, alternative, criteria, summary of decisions, and/or an associated objective. The identification component 432 may include using a processing (pre-processing and/or post-processing) analytics component 450, to assist with identifying the list of candidate subtopics, summaries, and a plurality of related data associated with the topic

The processing analytics component 450 may also be used to assist the identification component 432 with and/or to provide one or more recommendations or suggestions (via the UI component) to follow relating to the one or more transactions.

The advanced knowledge analysis and summarization system 430 may also include a summary component 435 and the extraction/summarization component 437 for grouping, clustering, and/or organizing the plurality of transaction elements according to similar transactions. The summary component 435 may group, cluster, and/or organize elements, transactions, alternative decisions/choices, and/or transaction criteria together based on the context, similar sentiments, similar concepts, and/or timestamp of the communications (e.g., audio/video data and/or text data having a timestamp indicating the communication occurs during the same time such as, for example, video data, audio data, notes, and/or text data of a meeting occurring at a selected time).

The advanced knowledge analysis and summarization system 430, using the summary component 435, the extraction/summarization component 437, the machine learning component, the transcription component 439, or a combination thereof, may combine the transaction elements with one or more transaction opportunities, transaction criteria, transaction objections, and historical data to provide a summary of the transaction elements, alternative entity transaction opportunities, required transaction elements for a future communication, or a combination thereof.

The advanced knowledge analysis and summarization system 430, using the summary component 435, the extraction/summarization component 437, the machine learning component, the transcription component 439, or a combination thereof, may link together each of the elements with identified sources of the element relating a topic of knowledge domain.

The advanced knowledge analysis and summarization system 430, using the summary component 435, the extraction/summarization component 437, the machine learning component, the transcription component 439, or a combination thereof, may assign a score indicating a degree of relevance to the topic for each candidate subtopics in the list of candidate subtopics, and/or assign a score indicating a degree of advancement in knowledge in relation to the topic for each candidate subtopic in the list of candidate subtopics.

The advanced knowledge analysis and summarization system 430, using the summary component 435, the extraction/summarization component 437, the machine learning component, the transcription component 439, or a combination thereof, may rank each candidate subtopic in the list of candidate subtopics based on a score assigned to each candidate subtopic in the list of candidate subtopics indicating a degree of knowledge advancement in relation to the topic.

The advanced knowledge analysis and summarization system 430, using the summary component 435, the extraction/summarization component 437, the machine learning component, the transcription component 439, or a combination thereof, may provide a knowledge graph of one or more candidate subtopic from the list of candidate subtopics.

The advanced knowledge analysis and summarization system 430, using the summary component 435, the extraction/summarization component 437, the machine learning component, the transcription component 439, or a combination thereof, may predict a list of tasks related to the list of candidate subtopics.

The advanced knowledge analysis and summarization system 430, using the summary component 435, the extraction/summarization component 437, the machine learning component, the transcription component 439, the UI component 434 or a combination thereof, may generate one or more expandable facets for one or more of the list of candidate subtopics depicting a plurality of data from the one or more data sources via an interactive graphical user interface (GUI).

A transcription component 439 may also be included in the advanced knowledge analysis and summarization system 430. For example, the transcription component 439 may be used to transcribe audio data or image/video data from one or more of the data sources 401-403. For example, a voice command/communication captured by the voice-activated detection device 404 (e.g., “voice command”) may be transcribed by the transcription component 439 into text data for natural language processing. As an additional example, the video data captured by the video capturing device 405 may be analyzed and transcribed by the transcription component 439 into text data for natural language processing.

The advanced knowledge analysis and summarization system 430 may also include a machine learning component 438. The machine learning component 438 may perform an analysis on the data from the data sources 401-403. The machine learning component 438 may apply one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural networks, Bayesian statistics, naive Bayes classifier, Bayesian network, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher’s linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

In one aspect, the domain knowledge may be an ontology of concepts representing a domain of knowledge. “Advanced knowledge” or “SoTa” knowledge may refer to an ontology of concepts representing a domain of knowledge with the most recent technology, developments, learning, testing, methods, operations, opinions, or understanding in relation to a particular domain of knowledge. That is, the advanced knowledge means the most recent stage in the development of technology, developments, learning, testing, methods, operations, opinions, or understanding, and features a domain knowledge.

A thesaurus or ontology may be used as the domain knowledge and may also be used to identify semantic relationships between observed and/or unobserved variables. In one aspect, the term “domain” is a term intended to have its ordinary meaning. In addition, the term “domain” may include an area of expertise for a system or a collection of material, information, content and/or other resources related to a particular subject or subjects. A domain can refer to information related to any particular subject matter or a combination of selected subjects.

The term ontology is also a term intended to have its ordinary meaning. In one aspect, the term ontology in its broadest sense may include anything that can be modeled as an ontology, including but not limited to, taxonomies, thesauri, vocabularies, and the like. For example, an ontology may include information or content relevant to a domain of interest or content of a particular class or concept. The ontology can be continuously updated with the information synchronized with the sources, adding information from the sources to the ontology as models, attributes of models, or associations between models within the ontology.

Additionally, the domain knowledge may include one or more external resources such as, for example, links to one or more Internet domains, webpages, and the like. For example, text data may be hyperlinked to a webpage that may describe, explain, or provide additional information relating to the text data. Thus, a summary may be enhanced via links to external resources that further explain, instruct, illustrate, provide context, and/or additional information to support a decision, alternative suggestion, alternative choice, and/or criteria.

In one aspect, the advanced knowledge analysis and summarization system 430 may perform one or more various types of calculations or computations. The calculation or computation operations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.). It should be noted that each of the components of the advanced knowledge analysis and summarization system 430 may be individual components and/or separate components of the advanced knowledge analysis and summarization system 430.

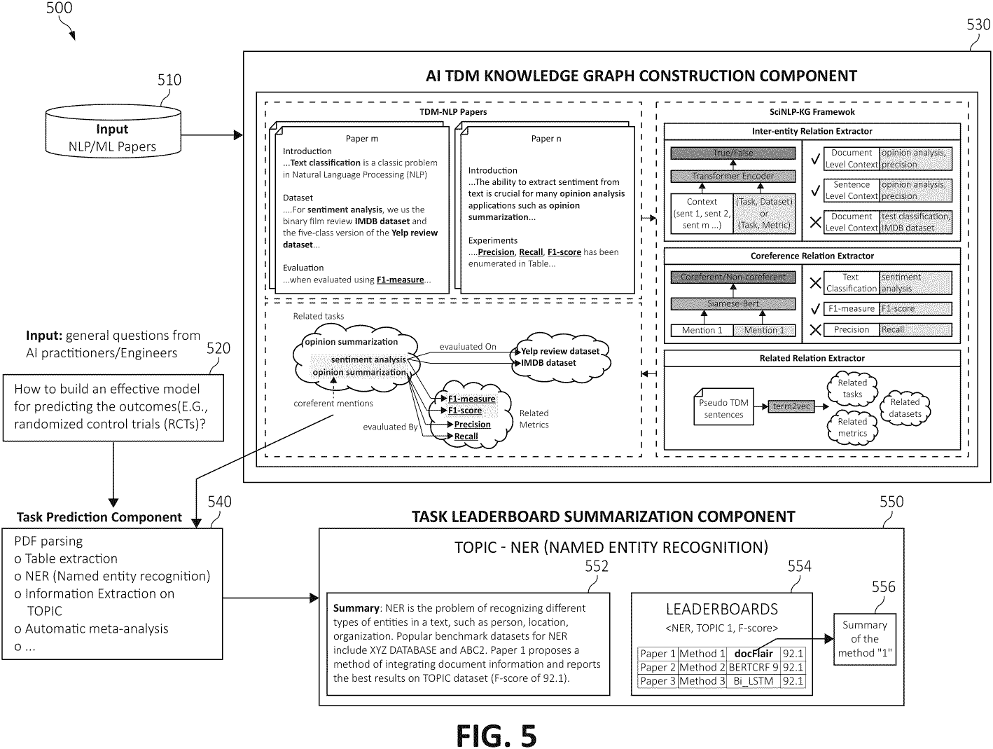

For further explanation, FIG. 5 is a block/flow diagram depicting an exemplary operations 500 for providing analysis and summarization of current knowledge of data in a computing environment by a processor in which aspects of the present invention may be realized. In one aspect, one or more of the components, modules, services, applications, and/or functions described in FIGS. 1-4 may be used in FIG. 5. For example, computer system/server 12 of FIG. 1, incorporating processing unit 16, may be used to perform various computational, data processing and other functionality described in FIG. 5. Repetitive description of like elements, components, modules, services, applications, and/or functions employed in other embodiments described herein is omitted for sake of brevity.

For example, input data 510 may be received by an AI “Task-Dataset-Metric” (“TDM”) knowledge graph construction component 530 (advanced knowledge analysis and summarization system 430) from one or more external resources (e.g., data sources 401-403 of FIG. 4 and may be DBpedia, WordNet, a domain knowledge, the Internet, etc.) The input data 510 may include, by way of example only, AI papers (e.g., NLP papers or machine learning papers relating to a particular topic). The input data 510 may also include done or more queries 520 such as, for example, general questions from AI practitioners/Engineers, such as, for example, “How to build an effective model for predicting the outcomes of randomized control trials (RCTs).

The AI TDM Knowledge Graph Construction Component 530 may be used to build a TDM knowledge graph from the received input 510 (e.g., AI scientific literature or generally referred to as “TDM-NLP” papers). The AI TDM Knowledge Graph Construction Component 530 may function as a TDM tagger that is trained to identify tasks, datasets, and/or metric entities from the input 510 (e.g., AI scientific literature) such as, for example, opinions, summaries, sentiment analysis, reviews, datasets, etc.

The AI TDM Knowledge Graph Construction Component 530 may train one or more extraction models to extract different types of relations from TDM entities, including an “evaluatedPOn” relation between a task and a dataset, “evaluatedBy” between a task and a metric, co-refence relation between the same type of entities (e.g., NER-Name Tagging), and related relation between the same type of entities (e.g., semantic role labeling is related to predicate identification) the relation extraction models are trained on annotated dataset on the document level using a BERT model.

An annotated dataset can be obtained using metadata. For each node, AI TDM Knowledge Graph Construction Component 530 may extract definition descriptions from the input data 510 (e.g., after a task, dataset, metric, and/or entities are mentioned in various papers, one or more syntactic rules can be used to extract definitions). For example, “NER is a task of ***” may be a definition description.

The AI TDM Knowledge Graph Construction Component 530 may build a knowledge graph. After the knowledge graph is built, the AI TDM Knowledge Graph Construction Component 530 may extract one or more valid triples (e.g., {Task, Dataset, Metric} triples) from the knowledge graph and the valid triples may be used to tag the input data 510 (e.g., tag the AI papers). For each of the input data (e.g., one or more AI paper), the AI TDM Knowledge Graph Construction Component 530 may extract one or more tuples such as, for example, the tuples of {Task, Dataset, Metric, Best score}. This will give us a leaderboard for each valid {Task, Dataset, Metric} triple.

The AI TDM Knowledge Graph Construction Component 530 may be in communication with a task prediction component 540 and a task leaderboard summarization component 550.

The task prediction component 540 may be used to parse data such as, for example, data or table extraction, NER, information extraction on a topic, and/or parse and automatically perform meta-data analysis on the data. The task prediction component 540 may predict a list of tasks, which are related to different sub-problems of the input 510 and/or input 520 such as, for example the query for a given scenario.

The task prediction component 540 may train a QA model to link the input 510 (e.g., a query or general question such as, for example, “How to build an effective model for predicting the outcomes of randomized control trials (RCTs)?”) to the task nodes in the knowledge graph built/generated by the AI TDM Knowledge Graph Construction Component 530.

The task prediction component 540 may collect training data such as, for example, {Question, Tasks} from tagged papers such as, for example, paper m and paper n in the AI TDM Knowledge Graph Construction Component 530. The task prediction component 540 may provide solutions/answers to the query or questions for the data from input 520, which are the task nodes from AI TDM Knowledge Graph Construction Component 530. The task prediction component 540 can be based a pre-trained question answering (QA) model. The model can be trained using a dataset which is collected based on the following heuristics: questions are converted from goals stated in papers (e.g., “this paper aims to ***”), and answers are the identified task entities based on the TDM tagger.

The machine learning model will learn a decomposition of tasks for different goals. The knowledge graph encodes related relations between tasks which can facilitate the QA model.

The task leaderboard summarization component 550 may be used to summarize the learned, advanced knowledge (e.g., SoTA results/methods) for a specific task. In some implementations, for a specific task, task leaderboard summarization component 550 may show the leaderboards of the learned, advanced knowledge (e.g., SoTA papers on various datasets). This can be done by the task leaderboard summarization component 550 retrieving and aggregating any relevant tuples such as, for example, the tuples of {task, dataset, metric, best score} from the AI TDM Knowledge Graph Construction Component 530. The task leaderboard summarization component 550 may extract the learned, advanced knowledge (e.g., a method extracted from each scientific paper). At the same time, the task leaderboard summarization component 550 may summarize the leaderboard in text format by training a table-to-text model.

When a user engages a specific method (e.g., docFlair) for a paper displayed in the leaderboard via GUI, the task leaderboard summarization component 550 may summarize the corresponding operation by extracting important sentences, paragraphs, formulas, tables, and/or other data related to the main/primary operation from the input data 510 (e.g., a scientific paper). The task leaderboard summarization component 550 may use an extractive summarization model to achieve this goal.

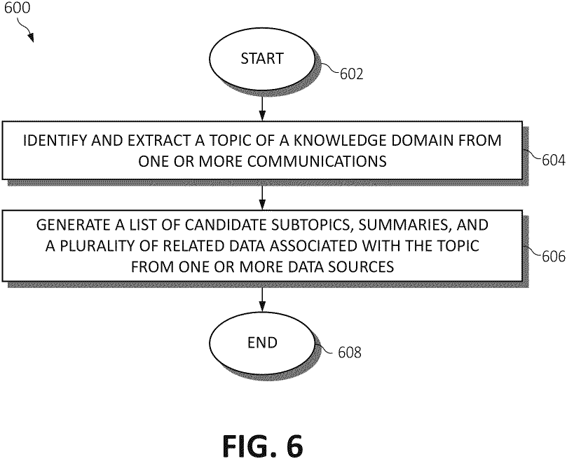

FIG. 6 is an additional flowchart diagram 600 depicting an additional exemplary method for providing analysis and summarization of current knowledge of data, again in which various aspects of the present invention may be realized. The functionality 600 may be implemented as a method executed as instructions on a machine, where the instructions are included on at least one computer readable medium or one non-transitory machine-readable storage medium. The functionality 600 may start in block 602.

A topic of a knowledge domain may be identified and extracted from one or more one or more data sources, as in block 604. A list of candidate subtopics, summaries, and a plurality of related data associated with the topic may be generated, as in block 606. The functionality 600 may end, as in block 608.

In one aspect, in conjunction with and/or as part of at least one block of FIG. 6, the operations of method 6700 may include each of the following. The operations of method 600 may assign a score indicating a degree of relevance to the topic for each candidate subtopics in the list of candidate subtopics. The operations of method 600 may assign a score indicating a degree of advancement in knowledge in relation to the topic for each candidate subtopic in the list of candidate subtopics.

The operations of method 600 may rank each candidate subtopic in the list of candidate subtopics based on a score assigned to each candidate subtopic in the list of candidate subtopics indicating a degree of knowledge advancement in relation to the topic.

The operations of method 600 may provide a knowledge graph of one or more candidate subtopic from the list of candidate subtopics. The operations of method 600 may predict a list of tasks related to the list of candidate subtopics. The operations of method 600 may generate one or more expandable facets for one or more of the list of candidate subtopics depicting a plurality of data from the one or more data sources via an interactive graphical user interface (GUI).

The operations of method 600 may define the elements as goals, criteria, transaction consensus or dissensions, alternative entity opportunities, identify the elements, the alternative entity opportunities, the required elements that pertain to the elements, link together each of the elements with identified sources of the elements in the one or more communications, and/or identify a consensus or dissension to the transaction elements by one or more users involved in the one or more communications.

The operations of method 600 may provide the summary (which may be a summary of the SoTA knowledge domain) via an interactive graphical user interface (GUI) on one or more computing devices and/or Internet of Things (IoT) devices. Additionally, the operations of method 600 may initialize a machine learning mechanism to perform one or more machine learning operations. The operations of method 600 may process the data/communications using natural language processing (NLP); convert an image or video data of the communications to text data; and/or convert audio data of the communications to text data.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for analysis and summarization of current knowledge of data by a processor, comprising:
identifying and extracting a topic of a knowledge domain from one or more data sources; and
generating a list of candidate subtopics, summaries, and a plurality of related data associated with the topic.

2. The method of claim 1, further including assigning a score indicating a degree of relevance to the topic for each candidate subtopics in the list of candidate subtopics.

3. The method of claim 1, further including assigning a score indicating a degree of advancement in knowledge in relation to the topic for each candidate subtopic in the list of candidate subtopics.

4. The method of claim 1, further including ranking each candidate subtopic in the list of candidate subtopics based on a score assigned to each candidate subtopic in the list of candidate subtopics indicating a degree of knowledge advancement in relation to the topic.

5. The method of claim 1, further including providing a knowledge graph of one or more candidate subtopic from the list of candidate subtopics.

6. The method of claim 1, further including predicting a list of tasks related to the list of candidate subtopics.

7. The method of claim 1, further including generating one or more expandable facets for one or more of the list of candidate subtopics depicting a plurality of data from the one or more data sources via an interactive graphical user interface (GUI).

8. A system for analysis and summarization of current knowledge of data, comprising:
one or more computers with executable instructions that when executed cause the system to:
identify and extract a topic of a knowledge domain from one or more data sources; and
generate a list of candidate subtopics, summaries, and a plurality of related data associated with the topic.

9. The system of claim 8, wherein the executable instructions when executed cause the system to assign a score indicating a degree of relevance to the topic for each candidate subtopics in the list of candidate subtopics.

10. The system of claim 8, wherein the executable instructions when executed cause the system to assign a score indicating a degree of advancement in knowledge in relation to the topic for each candidate subtopic in the list of candidate subtopics.

11. The system of claim 8, wherein the executable instructions when executed cause the system to rank each candidate subtopic in the list of candidate subtopics based on a score assigned to each candidate subtopic in the list of candidate subtopics indicating a degree of knowledge advancement in relation to the topic.

12. The system of claim 8, wherein the executable instructions when executed cause the system to provide a knowledge graph of one or more candidate subtopic from the list of candidate subtopics.

13. The system of claim 8, wherein the executable instructions when executed cause the system to predict a list of tasks related to the list of candidate subtopics.

14. The system of claim 8, wherein the executable instructions when executed cause the system to generate one or more expandable facets for one or more of the list of candidate subtopics depicting a plurality of data from the one or more data sources via an interactive graphical user interface (GUI).

15. A computer program product for analysis and summarization of current knowledge of data in a computing environment, the computer program product comprising:
one or more computer readable storage media, and program instructions collectively stored on the one or more computer readable storage media, the program instruction comprising:
program instructions to identify and extract a topic of a knowledge domain from one or more data sources; and
program instructions to generate a list of candidate subtopics, summaries, and a plurality of related data associated with the topic.

16. The computer program product of claim 15, further including program instructions to assign a score indicating a degree of relevance to the topic for each candidate subtopics in the list of candidate subtopics.

17. The computer program product of claim 15, further including program instructions to assign a score indicating a degree of advancement in knowledge in relation to the topic for each candidate subtopic in the list of candidate subtopics.

18. The computer program product of claim 15, further including program instructions to rank each candidate subtopic in the list of candidate subtopics based on a score assigned to each candidate subtopic in the list of candidate subtopics indicating a degree of knowledge advancement in relation to the topic.

19. The computer program product of claim 15, further including program instructions to:
provide a knowledge graph of one or more candidate subtopic from the list of candidate subtopics; and
predict a list of tasks related to the list of candidate subtopics.

20. The computer program product of claim 15, further including program instructions to generate one or more expandable facets for one or more of the list of candidate subtopics depicting a plurality of data from the one or more data sources via an interactive graphical user interface (GUI).
